(19) United States
(12) Patent Application Publication
(10) Pub. No.: US 2006/0168393 A1
(43) Pub. Date: Jul. 27, 2006

(54) Apparatus and method for dependency tracking and register file bypass controls using a scannable register file

(76) Inventors: Bjorn Peter Christensen, Austin, TX (US); Peter Juergen Klim, Austin, TX (US); Dung Quoc Nguyen, Austin, TX (US); Raymond Cheung Yeung, Round Rock, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/044,567

(22) Filed: Jan. 27, 2005

(51) Int. Cl. G06F 12/14

(52) U.S. Cl. 711/109

(57) ABSTRACT

An apparatus and method for dependency tracking and register file bypass controls using a scannable register file are provided. With the apparatus and method, a scannable register file array is provided and used to track the stage of any instruction in the execution unit. Every entry in the target vector is updated every cycle to stay synchronized with the instructions in the execution unit. To keep the register file array synchronized with the instructions in the execution unit, a right shift of all the data in each entry of the register file array occurs every cycle. The scan port of the register file array cells is used as the shift function.

### BACKGROUND OF THE INVENTION

1. Technical Field

The present invention relates generally to an improved data processing system and method. More specifically, the present invention provides an apparatus and method for dependency tracking and register file bypass controls using a scannable register file.

2. Description of Related Art

The basic structure of a conventional computer system includes one or more processing units connected to various input/output devices for the user interface (such as a display monitor, keyboard and graphical pointing device), a permanent memory device (such as a hard disk, or a floppy diskette) for storing the computer's operating system and user programs, and a temporary memory device (such as random access memory or RAM) that is used by the processor(s) in carrying out program instructions. The evolution of computer processor architectures has transitioned from the now widely-accepted reduced instruction set computing (RISC) configurations, to so-called superscalar computer architectures, wherein multiple and concurrently operable execution units within the processor are integrated through a plurality of registers and control mechanisms.

An illustrative embodiment of a conventional processing unit is shown in FIG. 1, which depicts the architecture for a PowerPC™ microprocessor 12 manufactured by International Business Machines Corporation. Microprocessor 12 operates according to reduced instruction set computing (RISC) and is a single integrated circuit superscalar microprocessor. The system bus 20 is connected to a bus interface unit (BIU) of microprocessor 12. Bus 20, as well as various other connections described, include more than one line or wire, e.g., the bus could be a 32-bit bus.

BIU 30 is connected to an instruction cache 32 and a data cache 34. The output of instruction cache 32 is connected to a sequencer unit 36. In response to the particular instructions received from instruction cache 32, sequencer unit 36 outputs instructions to other execution circuitry of microprocessor 12, including six execution units, namely, a branch unit 38, a fixed-point unit A (FXUA) 40, a fixed-point unit B (FXUB) 42, a complex fixed-point unit (CFXU) 44, a load/store unit (LSU) 46, and a floating-point unit (FPU) 48.

The inputs of FXUA 40, FXUB 42, CFXU 44 and LSU 46 also receive source operand information from general-purpose registers (GPRs) 50 and fixed-point rename buffers 52. The outputs of FXUA 40, FXUB 42, CFXU 44 and LSU 46 send destination operand information for storage at selected entries in fixed-point rename buffers 52. CFXU 44 further has an input and an output connected to special-purpose registers (SPRs) 54 for receiving and sending source operand information and destination operand information, respectively. An input of FPU 48 receives source operand information from floating-point registers (FPRs) 56 and floating-point rename buffers 58. The output of FPU 48 sends destination operand information to selected entries in rename buffers 58.

Microprocessor 12 may include other registers, such as configuration registers, memory management registers, exception handling registers, and miscellaneous registers, which are not shown. Microprocessor 12 carries out program instructions from a user application or the operating system, by routing the instructions and data to the appropriate execution units, buffers and registers, and by sending the resulting output to the system memory device (RAM), or to some output device such as a display console.

A high-level schematic diagram of a typical general-purpose register 50 is further shown in FIG. 2. GPR 50 has a block 60 labeled “MEMORY_ARRAY_{—}80×64,” representing a register file with 80 entries, each entry being a 64-bit wide word. Blocks 62a (WR0_DEC) through 62d (WR3_DEC) depict address decoders for each of the four write ports 64a-64d. For example, decoder 62a (WR0_DEC, or port 0) receives the 7-bit write address wr0_addr<0:6> (write port 64a). The 7-bit write address for each write port is decoded into 80 select signals (wr0_sel<0:79> through wr3_sel<0:79>). Write data inputs 66a-66d (wr0_data<0:63> through wr3_data<0:63>) are 64-bit wide data words belonging to ports 0 through 3 respectively. The corresponding select line 68a-68d for each port (wr0_sel<0:79> through wr3_sel<0:79>) selects the corresponding 64-bit entry inside array 60 where the data word is stored.

There are five read ports in this particular prior art GPR. Read ports 70a-70e (0 through 4) are accessed through read decoders 72a-72e (RD0_DEC through RD4_DEC), respectively. Select lines 74a-74e (rd0_sel<0:79> through rd4_sel<0:79>) for each decoder are generated as described for the write address decoders above. Read data for each port 76a-76e (rd0_data<0:63> through rd4_data<0:63>) follows the same format as the write data. The data to be read is driven by the content of the entry selected by the corresponding read select line.

In a microprocessor such as the one shown in FIG. 1, the result of an operation can be used before it has been written back to the register file, e.g., general purpose register. The result of the operation is forwarded directly to the dependent operation. On a deeply pipelined execution unit, the result can be forwarded even before the operation has completed. For example, an execution unit has eight stages of execution, but stages six, seven and eight may forward the partial result to a dependent operation.

To support forwarding of results, a multiplexer is used to either select the register file output or select the forwarding data from stages six, seven and eight. A method to generate the multiplexer control efficiently is needed.

One possible solution is to compare the source register of an instruction against the destination target of the executing instruction. In a processor where an instruction has several sources, many instructions, or several possible stages of bypass, the amount of compares may be large and thus, the corresponding area on the chip used by the comparison circuitry may be large.

Another possible solution is to track the location of instructions as they flow through the pipeline. An array of master-slave flip-flops (MSFFs) can be used to store the location of the pipeline stage an instruction is currently executing in. Since instructions move to a different stage every cycle, every entry in the array needs to be updated to reflect this. By using an array of MSFF, the area is larger than a register file of the same size. This approach may also have a slow read path causing timing problems.

Yet another approach may be to use a register file and read each entry, update the entry, and then write it back into the array. A read-update-write path would take at least one extra cycle causing performance degradation. Therefore, it would be beneficial to have an improved apparatus and method for tracking dependency and providing register file bypass controls.

### SUMMARY OF THE INVENTION

The present invention provides an apparatus and method for dependency tracking and register file bypass controls using a scannable register file, also referred to herein as a “target vector.” The “target vector” consists of a scannable register file array and stores data identifying the bypass control information of the instructions in the pipeline. The location of this bypass control information in the “target vector” is indicative of a position of the instruction within the execution pipeline.

Based on this position within the execution pipeline, a dependent instruction can determine whether or not it can bypass the remaining pipeline and obtain a result of the instruction for use by the dependent instruction. If the dependent instruction is not able to bypass the pipeline, the dependent instruction is halted in the pipeline while the instruction upon which it is dependent continues to progress through the pipeline. Once the instruction upon which the dependent instruction is dependent, is at a stage of the pipeline where the bypass is able to be performed, the halted instruction is allowed to proceed through the pipeline.

With the apparatus and method of the present invention, a scannable register file array, e.g., in GPR/FPRs, is provided and used to track the stage of any instruction in the execution unit. Every entry in the target vector is updated every cycle to stay synchronized with the instructions in the execution unit. By using existing circuitry present for scan, the cells in the register file array grow a minimal amount in order to facilitate the present invention. The present invention has the advantage of being smaller and faster than using master-slave flip-flops (MSFFs).

With a standard register file, the register file must read, and then update to keep the contents of the register file synchronized with the instructions in the execution unit. Since the data in the entries of the register file array need to be updated every cycle, a standard register file is unsuitable for this application.

To keep the register file array synchronized with the instructions in the execution unit, a right shift of all the data in each entry of the register file array occurs every cycle. The scan port of the register file array cells is used as the shift function. In known systems, the scan port is only used during register initialization or test mode but not during functional mode. The present invention uses the scan port during a functional mode to facilitate the shifting of the data in the register file array every cycle in order to maintain synchronization of the register file array with the instructions in the execution unit.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a processor in which an exemplary embodiment of the present invention may be implemented;

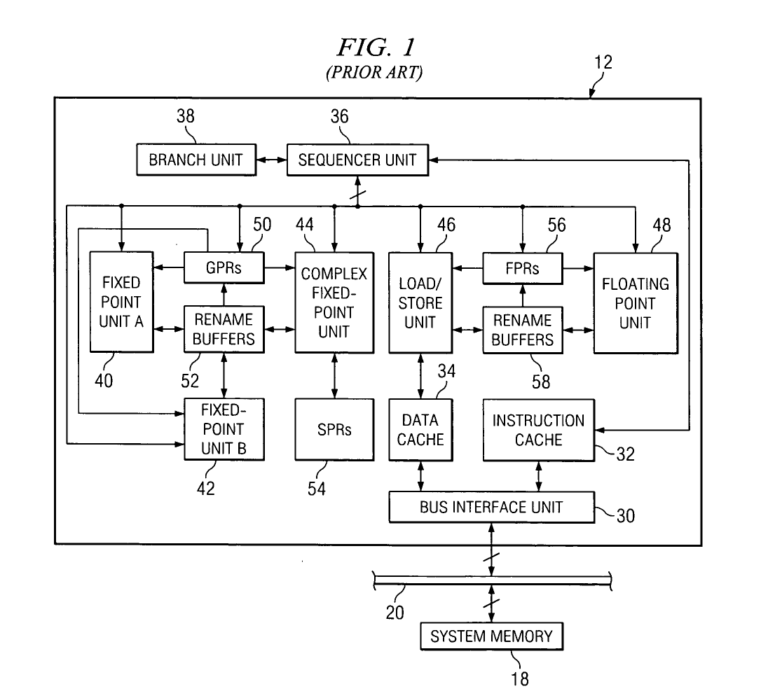

FIGS. 2A and 2B is a high-level schematic diagram of a typical general-purpose register;

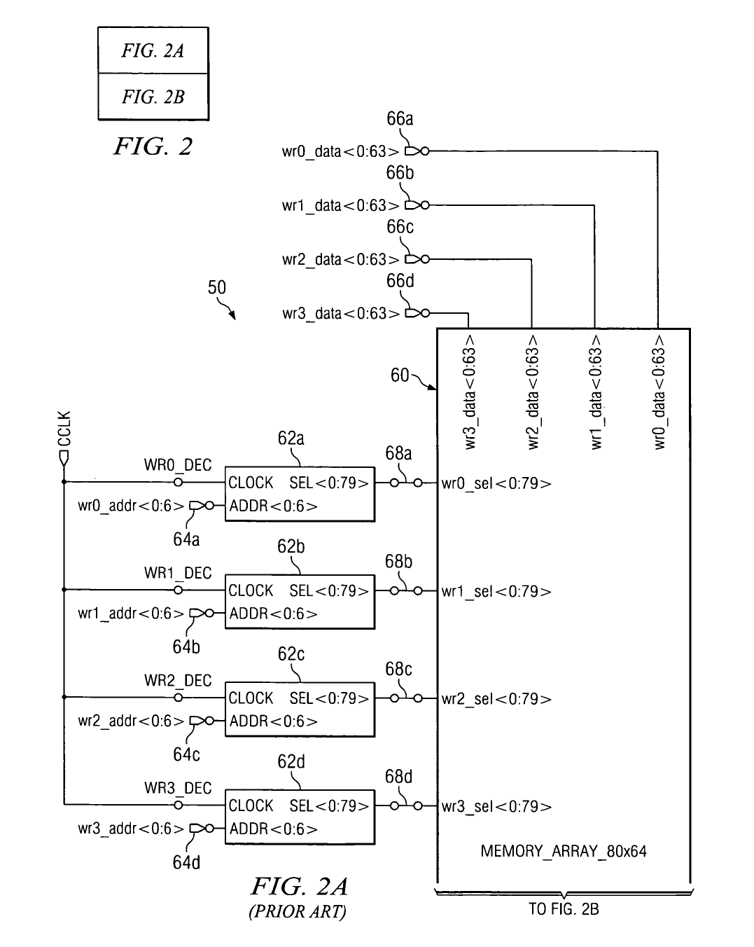

FIG. 3 is an exemplary diagram illustrating a pipeline in accordance with one exemplary embodiment of the present invention;

FIGS. 4A and 4B are exemplary diagrams that illustrate an exemplary operation of the present invention with regard to each stage of the pipeline shown in FIG. 3;

FIG. 5 is a circuit diagram of a register file cell in accordance with an exemplary embodiment of the present invention;

FIG. 6 is an exemplary diagram of a 3×2 register file array implementation example for illustrating the operation of one exemplary embodiment of the present invention;

FIG. 7 is an exemplary diagram illustrating a bit-line pre-charge circuit in accordance with one exemplary embodiment of the present invention;

FIG. 8 is an exemplary diagram of a clock steering control in accordance with one exemplary embodiment of the present invention; and

FIG. 9 is a flowchart outlining an exemplary operation in accordance with one exemplary embodiment of the present invention.

### DETAILED DESCRIPTION OF THE PREFERRED EMBODIMENT

The present invention provides a mechanism for using the scan port of register file array cells to shift data contents of the register file array cells during each instruction cycle of a pipelined processor. With such a mechanism the register file array is maintained synchronized with the instructions being processed by the pipelined processor.

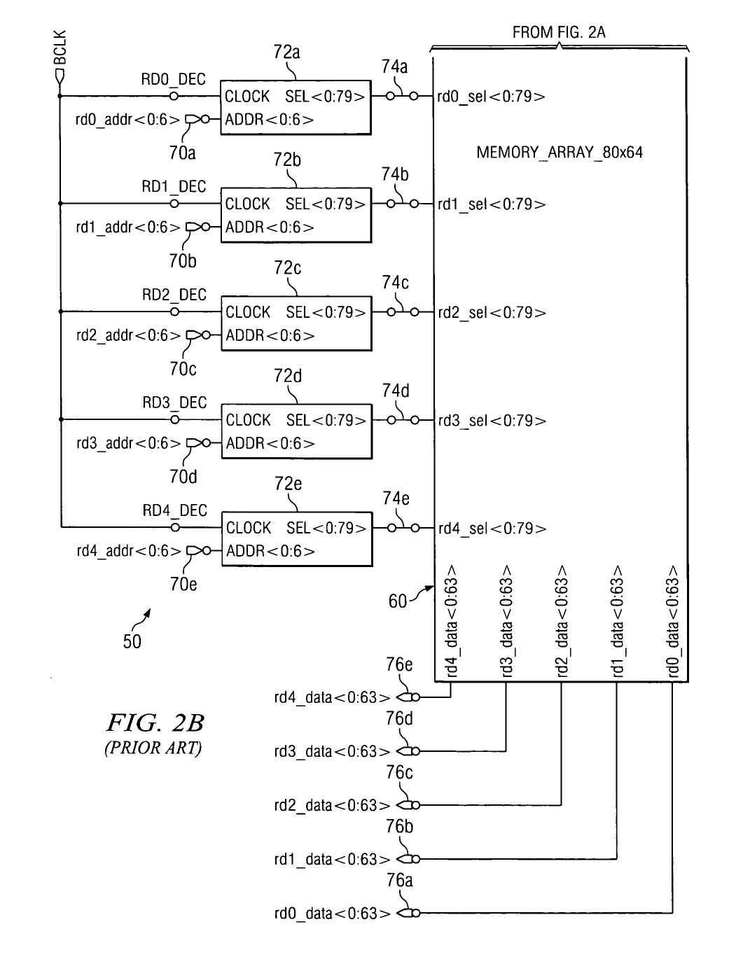

FIG. 3 illustrates a pipeline of a data processing system according to one exemplary embodiment of the present invention. With the present invention, as shown in FIG. 3 there are 11 relevant pipeline stages D0, D1, E0, E1 . . . E8. Stage D0 is the target vector read stage in which each instruction source reads data from the target vector. The target vector tracks which stage an instruction is currently located in. The target vector, in one exemplary embodiment of the present invention, is associated with a register file array of 32 entries by 8 entries wide. There is one read port for each source and one write port for each target in the register file array. To support two instructions with 3 sources, the register file array may have 6 read ports and 2 write ports. Each cycle, all the data in the register file array is right shifted.

Stage D1 is the instruction selection stage in which a determination is made as to whether a source is ready for the instruction. Stage E0 is the register file access stage in which the register file array is accessed based on read addresses from the source registers and bypass controls are provided to the output multiplexers of the register file array. Stages E1-E7 are the execute stages in which the data output from the register file array is processed by the instruction. Stage E8 is the write-back stage in which data is written back to the register file array.

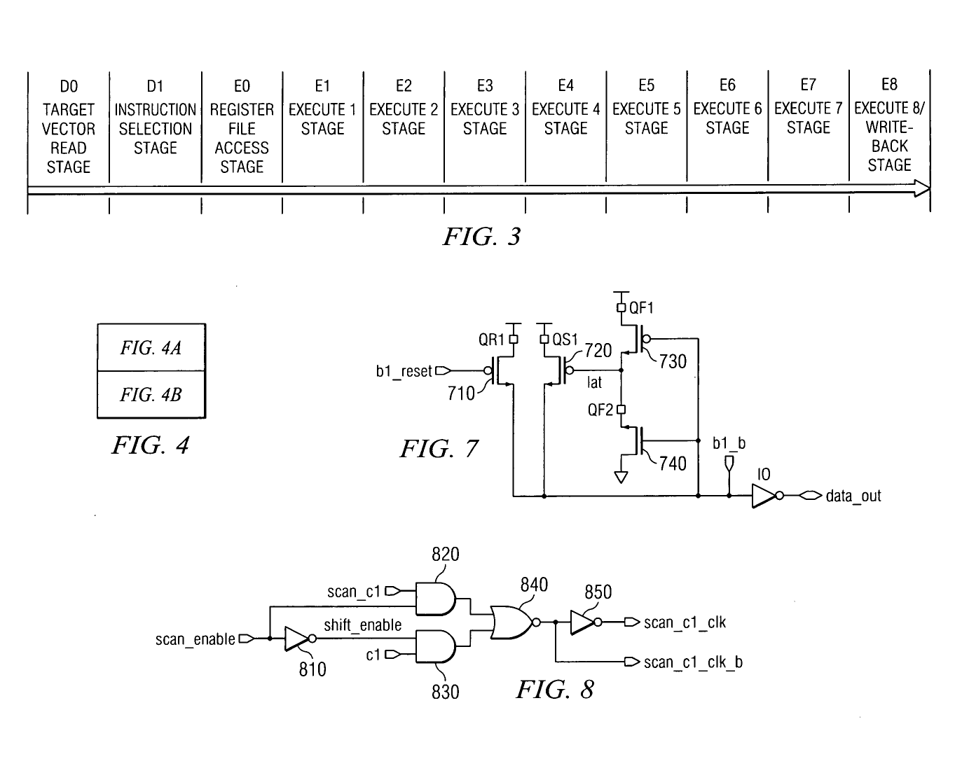

FIGS. 4A and 4B are exemplary diagrams that illustrate an exemplary operation of the present invention with regard to each stage of the pipeline shown in FIG. 3. As shown in FIG. 4A, in stage D0, the target vector 410 is read by each source (src a, src b, src c) 402-406. The output of the target vector 410 is stored in bypass control latches 412-416 and provided to the source ready logic units 420-424 and bypass control registers 430-434. The output of the target vector 410 is used in stage D1, by source ready logic units 420-424 to determine if the source register is ready and is later used in stage E0 to control the bypass multiplexers 470-474. A source register is ready if no older instruction has that register as a target unless that register can be bypassed.

As stated above, in stage D1, the bypass control values stored in the registers 412-416 are used by the source ready logic 420-424 to determine if a source is ready. The source ready logic checks if the output of the bypass controls equals “00000xxx” and if the destination in stage E0 does not match the source. Bits 5 to 7 of the bypass controls are passed to stage E0 for use as bypass controls by storing these bits in bypass control registers 430-434 which then provides these bits as input to the bypass multiplexers 470-474.

If the instruction is not ready, the instruction will stall the pipeline and stages D0 and D1 are held. When the pipeline is held, the data in the bypass control latches 430-434 of D1 are shifted right to stay synchronized with the corresponding instruction in the execution unit. For example, when an instruction is in E0, the instruction writes bit0 of the corresponding entry in the target vector and writes bit0 of the bypass controls of any dependent source.

The target vector tracks which stage an instruction is currently located in. For example, if there is an Add instruction with a destination target of register 1 and if the Add instruction is in E0, then bit0 (which corresponds to E0) of Row 1 (which corresponds to register 1) is set. If there is a younger instruction, such as a Subtract that has register 1 as a source, then the Subtract instruction must not issue because it is dependent upon the Add. The Subtract instruction must wait until the Add has progressed far enough down the pipeline such that the Add can bypass the result to the Subtract instruction. The bypass control bits of the Subtract instruction indicate which stage the Add is currently residing in. Thus, in the previous example where bit0 of the bypass controls of any dependent source are set is performed because if the Subtract instruction reads the target vector before the Add instruction has a chance to write the target vector, the Subtract instruction will not have the latest information about which registers are used by older instructions. Thus when the Add instruction is in E0 and a Subtract instruction is in D1, the Add instruction needs to set bit0 of the bypass controls to prevent the Subtract instruction from issuing.

During the register file access stage, E0, the contents of the register file array 460 are read based on the read addresses from sources 402-406 obtained via registers 440-454. The output data from the register file array 460 is provided to bypass multiplexers 470-474 which multiplex the data with data fed-back from stages E6, E7 and E8. Bypasses are selected with bypass control (bit 5) having the highest priority and bypass control (bit 7) having the lowest priority. Bypass control (bit 5) selects E6 data, bypass control (bit 6) selects E7 data, and bypass control (bit 7) selects E8 data. If all three bypass controls are inactive, the output of the register file array is selected.

The bypass multiplexers 470-474 output the source data corresponding to sources 402-406 as read from the register file array 460 or the bypass data as received from execution units 494-496 of stages E6-E8. The source data is stored in registers 480-484 prior to being provided to execution units 490-496. The execution units 490-496 perform instruction execution on the source data. The output of the execution units 494-496 is fed-back to the bypass multiplexers 470-474 for use in determining whether to bypass the data read from the register file array 460. Also, in stage E8, the stage E8 data is written back to the register file array 460.

It should be appreciated that the pipeline depicted in FIGS. 3, 4A and 4B is only exemplary and is not intended to state or imply any limitation as to the configuration or implementation of the processor pipeline used with embodiments of the present invention. For example, other implementations of the present invention may have more or less stages and the stages in which data can be bypassed may vary.

The register file array 460 of the present invention uses the scan path to perform the shifting of the necessary fields to maintain the register file array 460 consistent with the instructions being executed by the execution units of the pipeline. The scan path is essentially a shift register by nature. Thus, the present invention leverages the power of this shift register with minimal extra logic. A master-slave flip-flop is essentially what is needed to perform the shift function. The scan path is composed of master-slave flip-flops, thus the need to add extra latches to the register file array 460 is eliminated by using the scan path to perform the shifting in accordance with the present invention.

The scan clocks of the present invention are controlled through gating logic to prevent shifting during a write operation or during scan mode. During regular operation, the c2 clock is permitted to run free and causes the cells to shift their data values via the scan input/scan output ports from one cell to the next in the register file array. The c1 clock is used to control writing of input values to the first cell of the register file array. Thus, data may be written only to the first register file array cell and is shifted into each of the other cells with each clock c2 cycle. In this way, the scan path through the cells of the register file array resemble the flow of an instruction through the pipeline and may be used to keep track of the instruction as it progresses through the pipeline.

The following description of the circuitry of an exemplary embodiment of the present invention permits the novel register file array implementation using a target vector according to the present invention. The novel register file array contains all the necessary circuitry to implement the requirements of the target vector which is used to keep track of the present location of the instructions in the pipeline and its bypass controls.

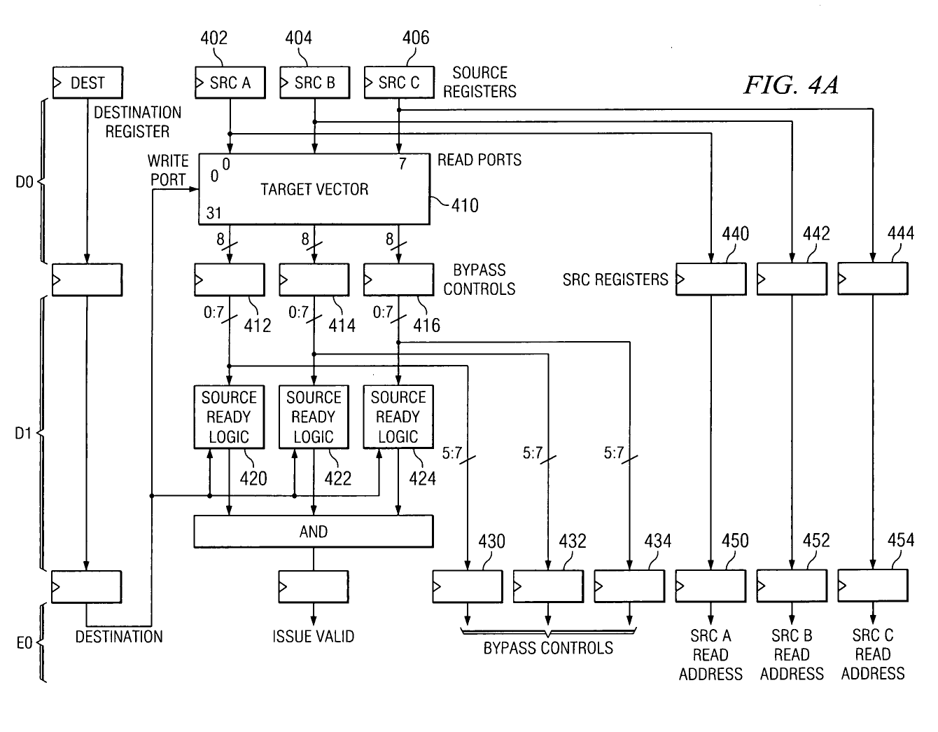

FIG. 5 is a circuit diagram of a register file cell in accordance with an exemplary embodiment of the present invention. As shown in FIG. 5, the register file cell is a scannable register file cell with a single read (rd_wl) and two write ports (wr_wl and wr_wl_b). The number of ports shown here are depicted to ensure clarity of description and are not intended to state or imply any limitation on the number of ports that may be used with a scannable register file cell of the present invention.

P-channel pass gate transistors Q5 510 and Q6 515 are turned on by the write word line wr_wl going low, passing true, i.e. 1 or “high,” and complement, i.e. 0 or “low,” into the cell storage nodes blb 525 and bl 520, respectively. Likewise, wr_wl_b going low turns on p-channel pass transistors Q7 530 and Q8 535 and the opposite of the previous write is written into the cell. That is bl node 520 is set low and blb node 525 is set high.

P-channel pass gates are chosen in the depicted implementation to take advantage of CMOS NAND gates as write word line drivers. However, other implementations of the present invention may make use of different logic elements which may be organized to achieve a similar purpose as the present invention without departing from the spirit and scope of the present invention.

The cell storage circuitry is made up from two back to back inverters consisting of p-channel device Q4 521, n-channel device Q3 522 and p-channel device Q2 540, n-channel device Q1 545 (which function like an inverter because n-channel QSC13 550 and p-channel QSC14 555 are on during functional operation).

The scan_in input 560 is connected to the input of the transmission gate consisting of n-channel QSC1 565 and p-channel QSC2 570. The gates of QSC1 565 and QSC2 570 are connected to scan clocks scan_c1 and its complement scan_c1_b (only issued in scan mode). The output of the transmission gate is connected to the true storage node bl 520. The scan clocks are connected to p-channel QSC14 555 and n-channel QSC13 550. When scan clocks scan_c1 and its complement scan_c1_b are active, both QSC14 555 and QSC13 550 are off to block the feedback path through Q1 545 and Q2 540. Hence the scan operation functions like a single ended write into the register file cell.

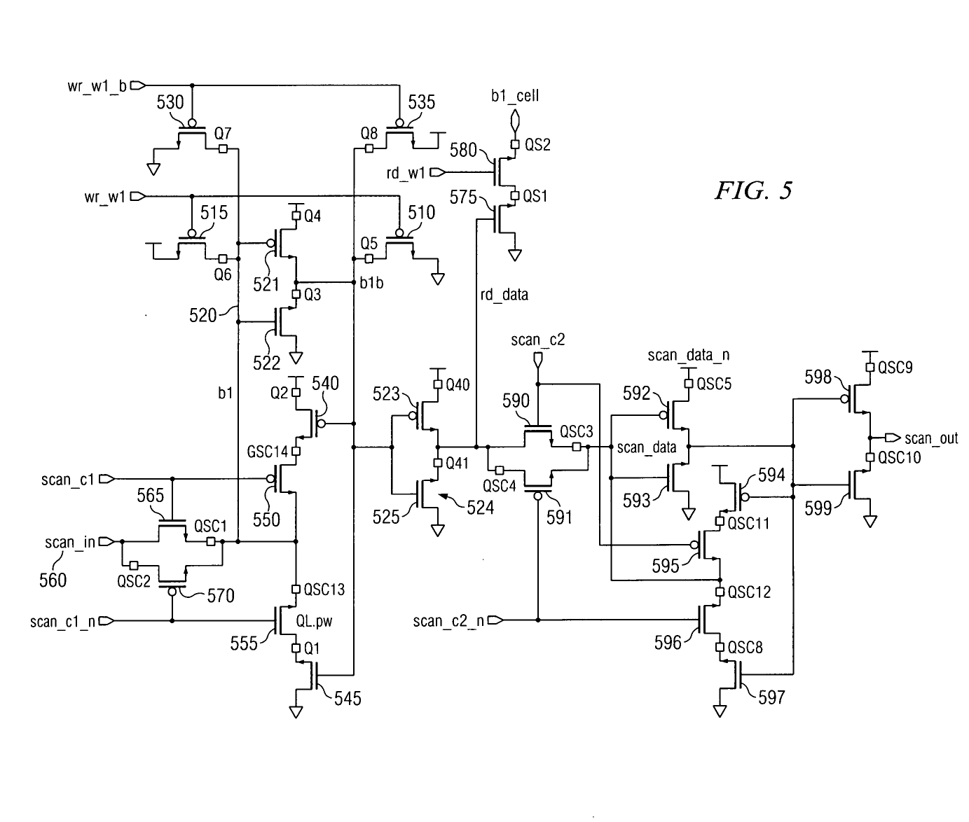

The inverter consisting of Q40 523 and Q41 524 inverts the complement latch node blb 525, which then drives the true value (rd_data) into the gate of n-channel Q51 575. The source of Q51 575 is connected to the drain of n-channel Q52 580. The gate of Q52 580 is connected to the read word line (rd_wl) which goes high when the row this register file cell is located in is accessed by a read operation. The drain of Q52 580 is connected to a standard domino bit-line (bl_cell), whose pre-charge device, half latch and output inverter are shown in FIG. 7, described hereafter.

The output of the primary register file cell (read_data) is also connected to the transmission gate consisting of n-channel device QSC3 590 and p-channel device QSC4 591. The gates of QSC3 590 and QSC4 591 are connected to clocks c2 and its complement c2_n which are free-running. The output of the transmission gate (scan_data) is connected to the scan latch consisting of QSC5 592 through QSC8 596, QSC11 597 and QSC12 596. This collection of transistors functions like the master register file cell consisting of Q1 545 through Q4 521, QSC13 550 and QSC14 555, where the scan_c1 clocks (test only) are in phase with functional write word line wr_wl but out of phase with the c2 clock. The inverter consisting of p-channel QSC9 598 and QSC10 599 inverts and connects the scan latch to the scan_in input of the adjacent register file cell.

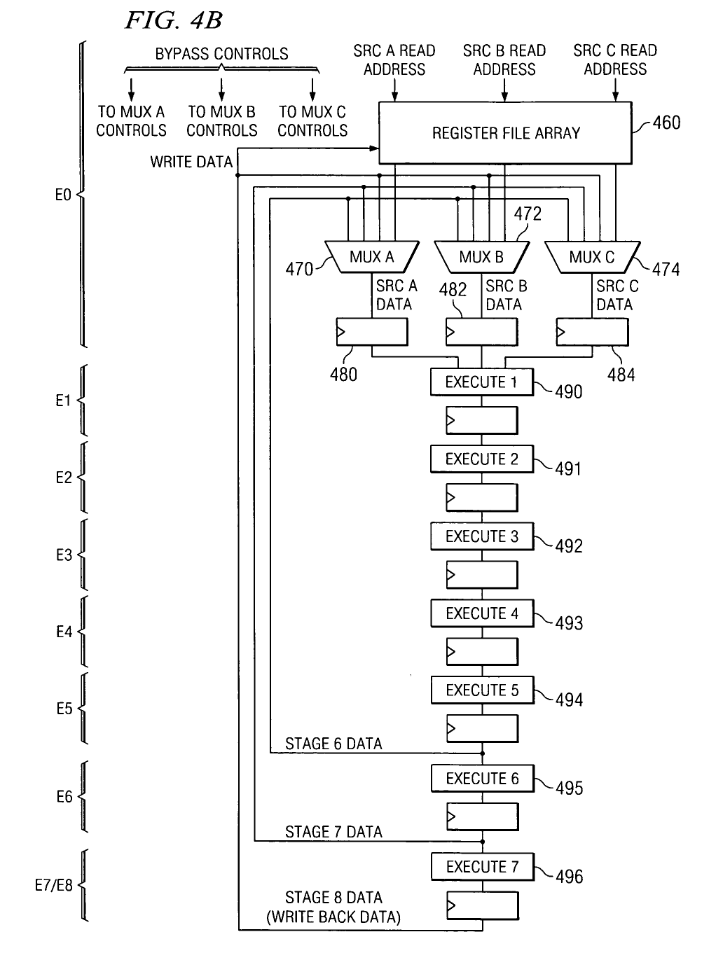

FIG. 6 is an exemplary diagram of a 3×2 register file array implementation example for illustrating the operation of one exemplary embodiment of the present invention. For clarity, the register file array shown is a subset of the actual register file array that would be used in practice. For example, while FIG. 6 illustrates only a 3×2 register file array, in an actual implementation of the present invention, the register file array may include a 32×8 register file array. It should be appreciated that while only a 3×2 register file array example is shown, the present invention is applicable to any size register file array and is not limited to any particular size register file array.

As shown in FIG. 6, the register file array consists of register file cells 610-660, such as those described in FIG. 5, that are oriented in two rows (entries) and three columns. Cell CELL0_{—}0 610 is located in row 0, column 0. Likewise, all other cell locations follow a similar naming convention, e.g., CELL1_{—}2 660 is located in row 1, column 2 (the third column since the first column is column 0).

The following description of the operation of the register file array shown in FIG. 6 is directed to the operation of row 0. It should be appreciated that the other rows, such as row 1, function in a similar manner and thus, a detailed description of the function of each row is not included herein.

With reference to FIG. 6, if wr_wl<0> (write select row 0) is low, the outputs of NAND0_{—}1 670 and NAND0_{—}0 671 are high. This is the write disable state for the wr_wl input of CELL0_{—}0 610. When the c1 clock goes high, the output of NAND0_{—}2 72 goes low (CELL0_{—}0 610 input wr_wl_b) and a zero is written into CELL0_{—}0 610. Likewise, if wr_wl<0> is high and data_in<0> (write target vector bit 0) is low, the output of NAND0_{—}1 670 is high. Consequently, when c1 goes high, a zero is written into CELL0_{—}0 610.

When data<0>is high and wr_wl<0> is high, the output of NAND0_{—}1 670 is low. Consequently, wr_wl_b is high and a zero may not be written into CELL0_{—}0 610. When c1 goes high the output of NAND0_{—}0 671 goes low (wr_wl of CELL0_{—}0 610), a one is written into CELL0_{—}0 610.

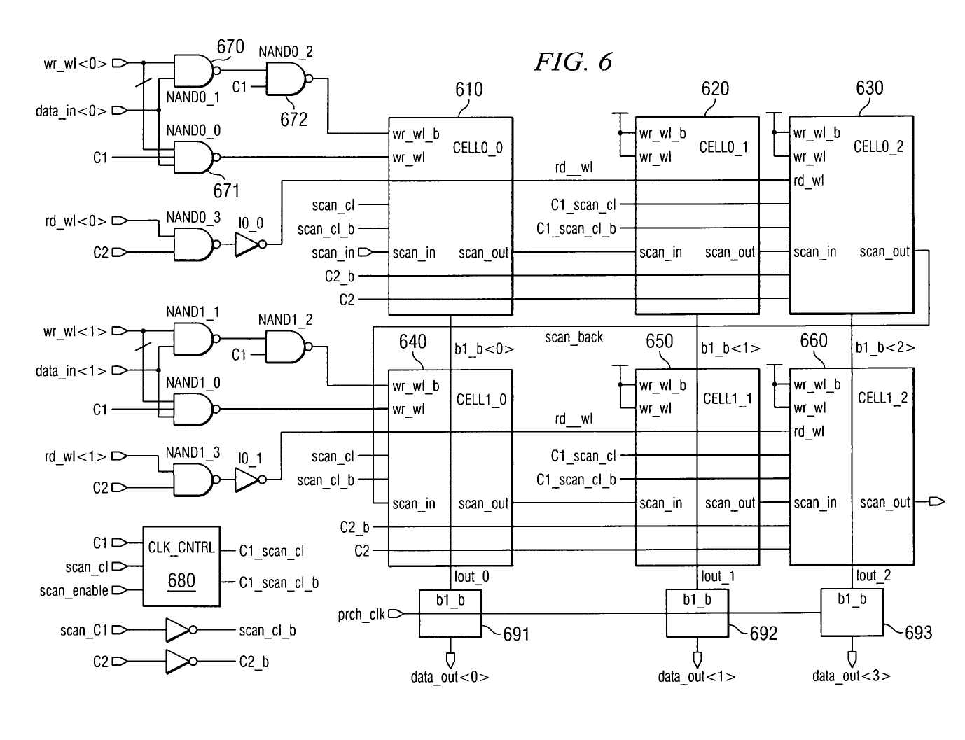

The shift function is implemented with the shift clock steering logic (block CLK_CNTRL 680) which is shown in greater detail in FIG. 8, described hereafter. When scan_enable is low (normal operation) the c1 clock is gated to the scan_c1_clk output and its complement to the scan_c1_clk_b output. During scan operation when scan_enable is high, scan clock scan_c1 is passed to the respective outputs of the shift clock steering logic.

Referring again to FIG. 6, it should be noted that the scan_c1 and scan_c1_b are directly connected to CELL0_{—}0 610 and CELL1_{—}0 640. The scan_in input of CELL0_{—}0 610 is hence used only for scan operation.

As described above, whenever c1 is high, data is written into the cell as described above. That is, when wr_wl<0> is high, a write operation writes the corresponding data_in<0> into CELL0_{—}0 610. If no write operation is desired (wr_wl<0> is low) a default zero is written into CELL0_{—}0 610 when c1 is active. Since the shift clock steering logic pulses c1_scan_c1 and c1_scan_c1_b high and low, respectively, for the duration of the c1 clock, data is shifted from CELL0_{—}0 610 to CELL0_{—}1 620 and from CELL0_{—}1 620 to CELL0_{—}2 630. Hence the data in CELL0_{—}2 630 is overwritten. Simultaneously, new data is written into CELL0_{—}0 610 as described above. Thus, this master/slave relationship between the cells in the register file array permits the data to be shifted from cell to cell in the register file array.

For detailed internal cell master slave operation, the description of FIG. 4 is referred to. It should be noted that during functional operation, the scan_back signal (scan_out of CELL0_{—}2 630) and scan_in input of CELL1_{—}0 620 are not clocked into CELL1_{—}0 640 since scan_c1 and scan_c1_b are disabled. During scan operation, however, CELL0_{—}0 610 through CELL1_{—}2 660 are connected as a single shift register.

The read is performed during the c2 phase. Only representative read operations for CELL0_{—}0 610 are described, however the other cells of the register file array operate in a similar manner. When rd_wl<0> goes high and c2 goes active (high) rd_wl signals of CELL0_{—}0 610 through CELL0_{—}2 630 go high. The drains of CELL0_{—}0 610 and CELL1_{—}0 640 are dotted together forming the bit-line for column 0. Likewise, bit lines are formed for each column between all cells 620 and 650, and 630 and 660, in the column. If a one is stored in CELL0_{—}0 610, the bit line is pulled low and data_out<0> goes high. If a zero was stored in CELL0_{—}0 610, the bit line remains at its pre-charge state with data_out<0> remaining low.

FIG. 7 is an exemplary diagram illustrating a bit-line pre-charge circuit in accordance with one exemplary embodiment of the present invention. As shown in FIG. 7, the circuit is identical for all bit lines (blocks iout_{—}0 691 though iout_{—}2 693 in FIG. 6). The circuit consists of the pre-charge device QR1 710 whose gate is connected to the pre-charge clock (c2_phase) labeled bl_reset (prch_clk in FIG. 6).

The bit line (bl_b) is pre-charged high, when c2 is low and p-channel QR1 710 is on, all read operations are disabled. Half latch p-channel device QS1 720 turns on when bl_b goes high as latch (lat) goes low inverted by the inverter formed by QF1 730 and QF2 740. After c2 goes high, the half latch maintains the high pre-charge state of the bit line until a cell with a one is read and the bit line is pulled low.

FIG. 8 is an exemplary diagram of a clock steering control in accordance with one exemplary embodiment of the present invention. As shown in FIG. 8, the clock steering control includes an inverter 810 coupled to an AND gate 830 which, along with AND gate 820, is coupled to a NOR gate 840. The output of the NOR gate 840 is in turn, coupled to inverter 850. The scan_enable signal is provided to inverter 810 and as an input to AND gate 820. The scan_c1 clock signal is provided as an input to AND gate 820 and the c1 clock signal is provided as an input to AND gate 830.

The inverter 810 receives the scan_enable signal and inverts the signal to generate a shift_enable signal which is also provided as an input to AND gate 830. The outputs from the AND gates 820 and 830 are provided to NOR gate 840. The output of NOR gate 840 is scan_c1_clk_b. The output of the NOR gate 840 is also provided to inverter 850 which inverts the scan_c1_clk_b signal to generate the scan_c1_clk signal.

With the circuitry of FIG. 8, when the scan enable signal is high, the shift_enable signal is low. If the clock signal c1 is high, then the output of AND gate 830 is low. If the clock signal c1 is low, then the output of the AND gate 830 is low. Similarly, if the scan_enable signal is low, the shift_enable signal is high. As a result, when c1 is high, the output of AND gate 830 is high and when c1 is low, the output of AND gate 830 is low.

When the scan_enable signal is high and the scan_c1 signal is high, the output of AND gate 820 is high. When the scan_enable signal is high and the scan_c1 signal is low, then the output of the AND gate 820 is low. Similalry, when the scan_enable signal is low and the scan_c1 signal is high, the output of AND gate 820 is low. When the scan_enable signal is low and the scan c1 signal is low, the output of the AND gate 820 is low.

With regard to the outputs of the AND gates 820 and 830, when the output of AND gate 820 is low and the output of AND gate 830 is high, or vice versa, the NOR gate 840 output is low. When the output of AND gate 820 is low and the output of AND gate 830 is low, the output of NOR gate 840 is high. The inverter 850 inverts the output of the NOR gate 840 to generate the scan_c1 _clk signal.

Using the circuitry shown in FIG. 8 above, the shift clock steering logic pulses c1_scan_c1 (i.e. scan_c1_clk) and c1_scan_c1_b (i.e. scan_c1_clk_b) high and low. As a result, data is shifted from CELL0_{—}0 610 to CELL0_{—}1 620 and from CELL0_{—}1 620 to CELL0_{—}2 630 in FIG. 6.

With the circuitry described above, when an instruction enters the pipeline, bit0 of the first cell of the register file array is written to indicating that the instruction is present at the first stage of the pipeline. With each cycle, the bit0 value is shifted to a next cell of the register file array via the scan path. If a dependent instruction is to be issued into the pipeline, the dependent instruction first reads the register file array to determine the location of the instruction from which it is dependent. The location of the bit0 value in the register file array is indicative of which stage of the pipeline the instruction is currently in. Based on this location, it is determined whether the remainder of the pipeline for the instruction may be bypassed and the result of the instruction provided to the dependent instruction. If the remainder of the pipeline cannot be bypassed, the dependent instruction is halted in the pipeline while the instruction upon which it is dependent continues to progress through the pipeline with each cycle. Once the instruction is at a stage where the result may be utilized by the dependent instruction, the dependent instruction is permitted to progress through the pipeline.

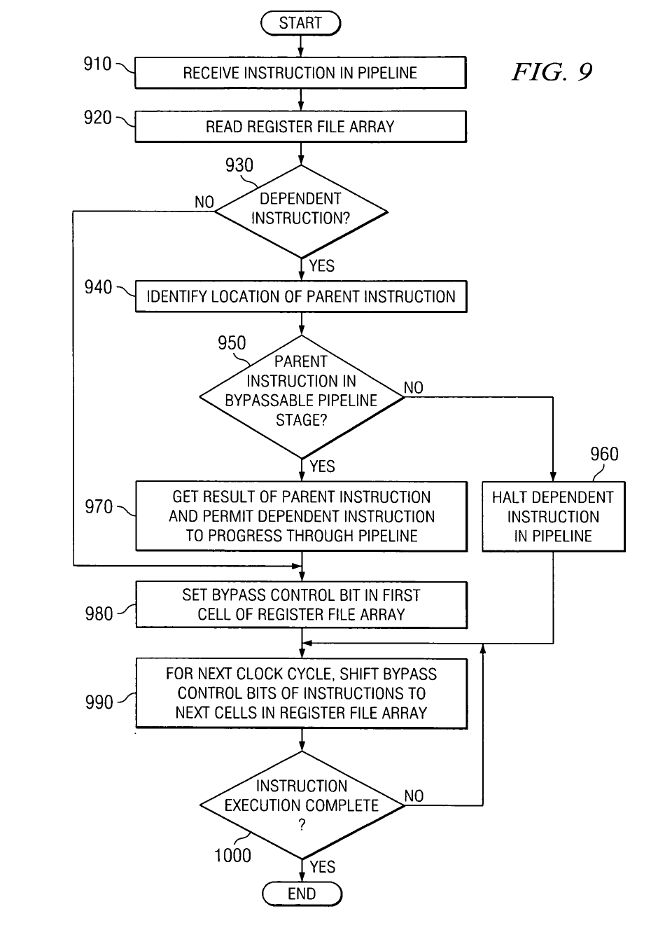

FIG. 9 is a flowchart outlining an exemplary operation in accordance with one exemplary embodiment of the present invention. As shown in FIG. 9, the operation starts by receiving an instruction in the pipeline for processing (step 910). The register file array is read to identify the position of any instructions in the pipeline (step 920). A determination is made as to whether the present instruction is a dependent instruction (step 930). If the present instruction is a dependent instruction, the location, within the register file array, of the instruction upon which the present instruction is dependent is identified (step 940). A determination is made as to whether this location corresponds to a stage of the pipeline from which the result of the instruction may be bypassed (step 950). If not, the current instruction is halted in the pipeline (step 960). If the instruction is in a stage of the pipeline from which its result may be bypassed, the result is provided to the dependent instruction and the dependent instruction is permitted to progress through the pipeline (step 970).

Thereafter, a bypass control bit is set in a first cell of the register file array (step 980). For the next clock cycle, the bypass control bit is shifted to a next cell in the register file array (step 990). A determination is made as to whether the instruction's execution in the pipeline has completed (step 1000). If so, the operation terminates. Otherwise, the operation returns to step 990 for the next cycle of pipeline execution.

Thus, the present invention provides a mechanism for tracking the progress of an instruction through an execution pipeline using a scannable register file array. With the mechanism of the present invention, the scan path through a register file array is used to write a bypass control bit into the cells of the register file. This bypass control bit is right shifted from cell to cell in the register file array with each pipeline clock cycle. In this way, the position of the bypass control bit in the scannable register file array is indicative of the position of the instruction within the pipeline. The location of the bypass control bit for an instruction in the scannable register file array may be used by a dependent instruction to determine if the dependent instruction may bypass the remainder of the pipeline and obtain the result of the instruction from which it is dependent.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. An apparatus for accessing a register file array in a data processing system comprising:
a register file array having a plurality of cells; and
a shift clock steering circuit coupled to the register file array, wherein the shift clock steering circuit controls shifting of data from one cell to another cell in the register file array via scan ports of the plurality of cells such that data is shifted from one cell to another, cell at each clock cycle.

2. The apparatus of claim 1, wherein a cell in which the data is currently present is indicative of a stage in an instruction pipeline in which the instruction is currently present.

3. The apparatus of claim 2, wherein data is written to a first cell of the register file array using a scan in port of the first cell when an instruction is issued to the instruction pipeline, and wherein the data is shifted to another cell in the register file array using a scan out port of the first cell at a next clock cycle.

4. The apparatus of claim 1, wherein the shift clock steering circuit pulses two clock signals that cause the data from one cell to shift to another cell in the register file array.

5. The apparatus of claim 1, wherein data is written to a first cell of the register file array only when a write word line signal is high and a first clock signal from the shift clock steering circuit is high.

6. The apparatus of claim 1, further comprising a plurality of bit line pre-charge circuits, wherein the plurality of cells of the register file array are arranged in columns and rows, and wherein the plurality of bit line pre-charge circuits are coupled to columns of cells in the register file array, one pre-charge circuit for each column in the register file array.

7. The apparatus of claim 6, wherein each cell in a first column of cells of the plurality of cells in the register file array receives a first clock signal and its complement and a second clock signal and its complement, and wherein the first clock signal is high when data is to be written to a corresponding cell in the first column of cells, and wherein the second clock signal is free running such that the second clock signal causes shifting of data written to the first column of cells to cells in a next column of cells of the plurality of cells in the register file array.

8. The apparatus of claim 1, wherein the plurality of cells of the register file array are arranged as a scan chain in which a scan output port of a first cell of the plurality of cells in the register file array is coupled to a scan in port of a next cell of the plurality of cells in the register file array.

9. The apparatus of claim 1, wherein each cell in the plurality of cells in the register file array is a scannable register file cell with a single read port and two write ports.

10. The apparatus of claim 1, wherein the register file array comprises an array of register file array cells having 32 columns and 8 rows.

11. A method for accessing a register file array in a data processing system comprising:
receiving an instruction into an instruction pipeline;
storing a data value associated with the instruction in a first cell of a register file array having a plurality of cells; and
shifting the data value from the first cell to another cell in the register file array using a shift clock steering circuit coupled to the register file array, wherein the shift clock steering circuit controls shifting of data from one cell to another cell in the register file array via scan ports of the plurality of cells such that data is shifted from one cell to another cell at each clock cycle.

12. The method of claim 11, wherein a cell in which the data is currently present is indicative of a stage in the instruction pipeline in which the instruction is currently present.

13. The method of claim 12, wherein data is written to the first cell of the register file array using a scan in port of the first cell when the instruction is issued to the instruction pipeline, and wherein the data is shifted to another cell in the register file array using a scan out port of the first cell at a next clock cycle.

14. The method of claim 11, wherein the shift clock steering circuit pulses two clock signals that cause the data from one cell to shift to another cell in the register file array.

15. The method of claim 11, wherein data is written to the first cell of the register file array only when a write word line signal is high and a first clock signal from the shift clock steering circuit is high.

16. The method of claim 11, wherein the plurality of cells of the register file array are arranged in columns and rows, and wherein a plurality of bit line pre-charge circuits are coupled to columns of cells in the register file array, one pre-charge circuit for each column in the register file array.

17. The method of claim 16, wherein each cell in a first column of cells of the plurality of cells in the register file array receives a first clock signal and its complement and a second clock signal and its complement, and wherein the first clock signal is high when data is to be written to a corresponding cell in the first column of cells, and wherein the second clock signal is free running such that the second clock signal causes shifting of data written to the first column of cells to cells in a next column of cells of the plurality of cells in the register file array.

18. The method of claim 11, wherein the plurality of cells of the register file array are arranged as a scan chain in which a scan output port of a first cell of the plurality of cells in the register file array is coupled to a scan in port of a next cell of the plurality of cells in the register file array.

19. The method of claim 11, wherein each cell in the plurality of cells in the register file array is a scannable register file cell with a single read port and two write ports.

20. The method of claim 11, wherein the register file array comprises an array of register file array cells having 32 columns and 8 rows.
